(19) United States
(12) Patent Application Publication
(10) Pub. No.: US 2012/0158608 A1
(43) Pub. Date: Jun. 21, 2012

(54) FLEET DISPATCH PLAN OPTIMIZATION

(75) Inventors: Sundar ARUNAPURAM, West Chester, PA (US); Yun WANG, Lansdale, PA (US); Marybeth ROBERTS, Downingtown, PA (US)

(73) Assignee: ORACLE INTERNATIONAL CORPORATION, Redwood Shores, CA (US)

(21) Appl. No.: 13/152,512

(22) Filed: Jun. 3, 2011

Related U.S. Application Data
(60) Provisional application No. 61/424,297, filed on Dec. 17, 2010.

(51) Int. Cl. G06Q 10/00

(52) U.S. Cl. 705/334

(57) ABSTRACT

One embodiment is a fleet dispatch plan optimization system and method that provides a planning and assignment mechanism for assigning shipments of goods, supplies, cargo, or any other type of delivery to a driver and equipment. The method may include, for example, receiving as an input a plurality of shipments of items or goods that need to be assigned and a plurality of drivers available to handle the shipments. The drivers can include those from the private fleet or from a common carrier. The method may then include determining, using a simulation engine for example, the most cost effective assignment of one of the drivers to at least one of the shipments.

### CROSS REFERENCE TO RELATED APPLICATIONS

This application claims priority from provisional application Ser. No. 61/424,297, filed on Dec. 17, 2010, the contents of which is hereby incorporated by reference in its entirety.

### FIELD

One embodiment is directed generally to computerized logistics and, in particular, to an optimized plan for fleet dispatch.

### BACKGROUND INFORMATION

Companies that sell or deliver goods, as well as operators of fleet vehicles, need to monitor and manage the deployment, location, and routes of their shipments. Companies seek to do so in a manner that increases asset utilization, lowers transportation costs, and complies with local and national regulations related to employment, environment, etc. For example, one aspect of the monitoring and managing of shipments is being able to determine how to efficiently and optimally assign resources, vehicles, and/or drivers to certain shipments.

The efficient management and assignment of shipments can be complicated by the fact that many companies utilize both private carriers and common carriers to transport their shipments. When companies utilize their own private fleets to transport their own goods, this fleet is referred to as a private carrier. Usually companies have their own private carriers even when their primary business is not transportation. For instance, grocery store chains and restaurant chains often have private fleets to carry their goods to their different locations. A private carrier is distinguished from a common carrier whose primary business is the transport of goods. Common carriers offer their services to the general public under license. Thus, common carriers generally transport goods according to defined and published routes, time schedules, and rate tables upon the approval of regulators. In some jurisdictions, the functional equivalent of a common carrier is referred to as a public carrier.

Therefore, determining the best way to move or transport goods using the different available resources, vehicles, drivers and/or carriers can pose a significant challenge for companies.

### SUMMARY

One embodiment is directed to a computer program, embodied on a computer readable medium. The computer program is configured to control a processor to perform a process that includes retrieving a list of available drivers and shipments, determining feasibility of assigning one of the drivers to one of the shipments, determining a cost of assigning each of the drivers to each of the shipments, and selecting a lowest cost assignment of a driver to the shipments based on a result of the determining. The drivers may be drivers for the private fleet owned by the company that owns the shipments, or the drivers may be common carrier drivers.

### BRIEF DESCRIPTION OF THE DRAWINGS

FIG. 1 illustrates a system according to one embodiment of the invention;

FIG. 2 illustrates a flow diagram of a method according to an embodiment;

FIG. 3 illustrates a flow diagram of a method according to an embodiment;

FIG. 4 illustrates a graphical user interface according to an embodiment; and

FIG. 5 illustrates a graphical user interface according to an embodiment.

### DETAILED DESCRIPTION

One embodiment is a fleet dispatch plan optimization system and method that provides a planning and assignment mechanism for assigning shipments of goods, products, supplies, cargo, or any other type of delivery to a driver and equipment. The method may include, for example, receiving as an input a plurality of shipments of items or goods that need to be assigned and a plurality of drivers available to handle the shipments. The drivers can include those from the private fleet or from a common carrier. The method may then include determining, using a simulation engine for example, the most cost effective assignment of one of the drivers to at least one of the shipments.

In this description, equipment may be referred to as resources, containers, trailers, or the like. According to certain embodiments, equipment can be anything used to store, transport, or ship items such as goods or products.

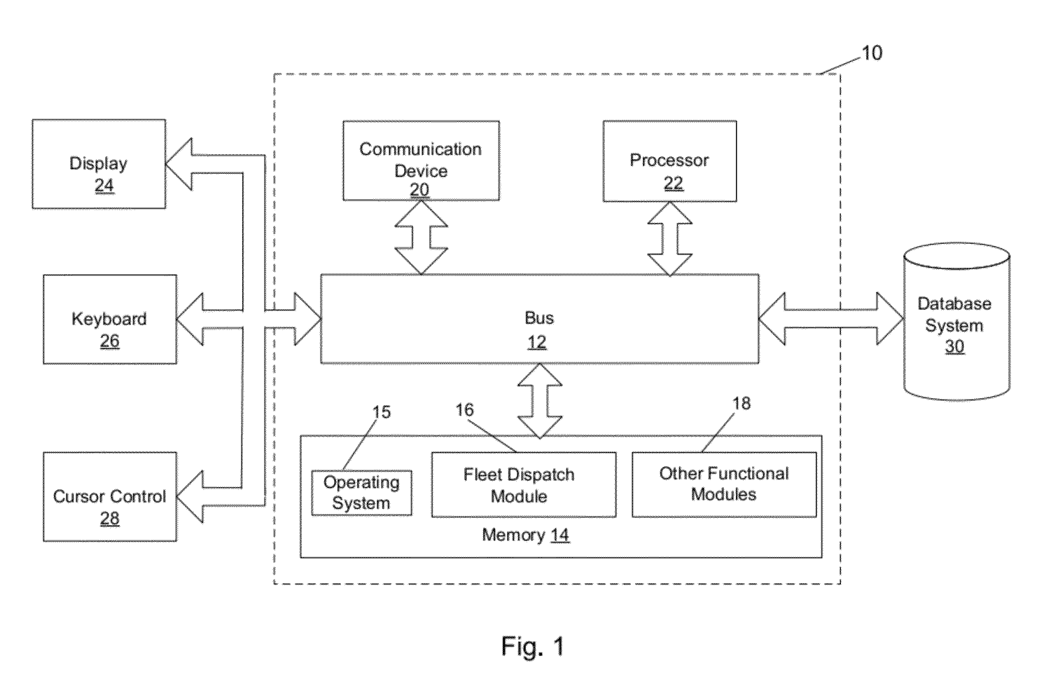

FIG. 1 illustrates a block diagram of a system 10 that may implement fleet dispatch plan optimization, according to one embodiment. System 10 includes a bus 12 or other communications mechanism for communicating information between components of system 10. Alternatively, the components of system 10 may communicate with each other directly without the use of bus 12.

System 10 also includes a processor 22, coupled to bus 12, for processing information and executing instructions or operations. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer readable media. System 10 further includes a communication device 20, such as a network interface card or other communications interface, to provide access to a network. As a result, a user may interface with system 10 directly or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user, such as the fleet dispatch plan, as will be discussed in more detail below. A keyboard 26 and a cursor control device 28, such as a computer mouse, are further coupled to bus 12 to enable a user to interface with system 10.

Processor 22 and memory 14 may also be coupled via bus 12 to a database system 30 and, thus, may be able to access and retrieve information stored in database system 30. Although only a single database is illustrated in FIG. 1, any number of databases may be used in accordance with certain embodiments. In some embodiments, database system 30 may store information related to items for shipping including their dimensions, weight, volume, current location, destination, and any other relevant attributes. In addition, database system 30 may store information related to drivers, such as their available hours, locations, restrictions, etc. Database system 30 may also store information related to containers, including their size, dimensions, attributes such as any obstructions, etc.

In one embodiment, memory 14 stores software modules that provide functionality when executed by processor 22. The modules may include an operating system 15 that provides operating system functionality for system 10. The memory may also store a fleet dispatch module 16, which can provide the functionality for determining the most optimal assignment of drivers to shipments, according to one embodiment.

System 10 may also include one or more other functional modules 18 to provide additional functionality. For example, functional modules 18 may include a transportation management system capable of facilitating the planning and building of shipments. In one embodiment, functional modules 18 may include, for instance, the Oracle Transportation Management (OTM) system from Oracle Corporation.

Database system 30 may include a database server and any type of database, such as a relational or flat file database. Database system 30 may store attributes related to items and container, as well as constraints provided by the transportation management system or a user. Database system 30 may also store any other data required by fleet dispatch module 16, or data associated with system 10 and its associated modules and components.

In certain embodiments, processor 22, fleet dispatch module 16, and other functional modules 18 may be implemented as separate physical and logical units or may be implemented in a single physical and logical unit. Furthermore, in some embodiments, processor 22, fleet dispatch module 16, and other functional modules 18 may be implemented in hardware, or as any suitable combination of hardware and software.

In one embodiment, fleet dispatch module 16 is configured to control system 10 to determine the lowest cost, feasible assignment of drivers to shipments. In making the determination, fleet dispatch module 16 is able to adhere to any business constraints or parameters with respect to drivers, equipment, locations, and orders. Business constraints may include, for example, the drivers being domiciled at different locations, each with their own remaining available driving hours and/or work hours in accordance with the Department of Transportation rules and regulations. In addition, business constraints may include scheduling requirements, such as requirements for date and time of completing deliveries.

In one embodiment, fleet dispatch module 16 utilizes a column generation framework in order to separate the problem of optimal assignment of one or more shipments to drivers from the business constraints associated with the shipments and drivers. According to an embodiment, the column generation framework works iteratively to solve a relaxed linear programming (LP) problem with a subset of all possible driver assignments at every iteration. The LP solution provides useful information that can be used to generate additional driver assignments that contribute to a better overall solution. In an embodiment, the generation of driver assignments can be performed using a shortest path algorithm that uses real world business scenarios and constraints, such as drivers' hours of service rules, complex rate structures and any other of a number of applicable constraints. Further, fleet dispatch module 16 is able to determine the best assignment of drivers between both the internal fleet and external common carrier fleet(s).

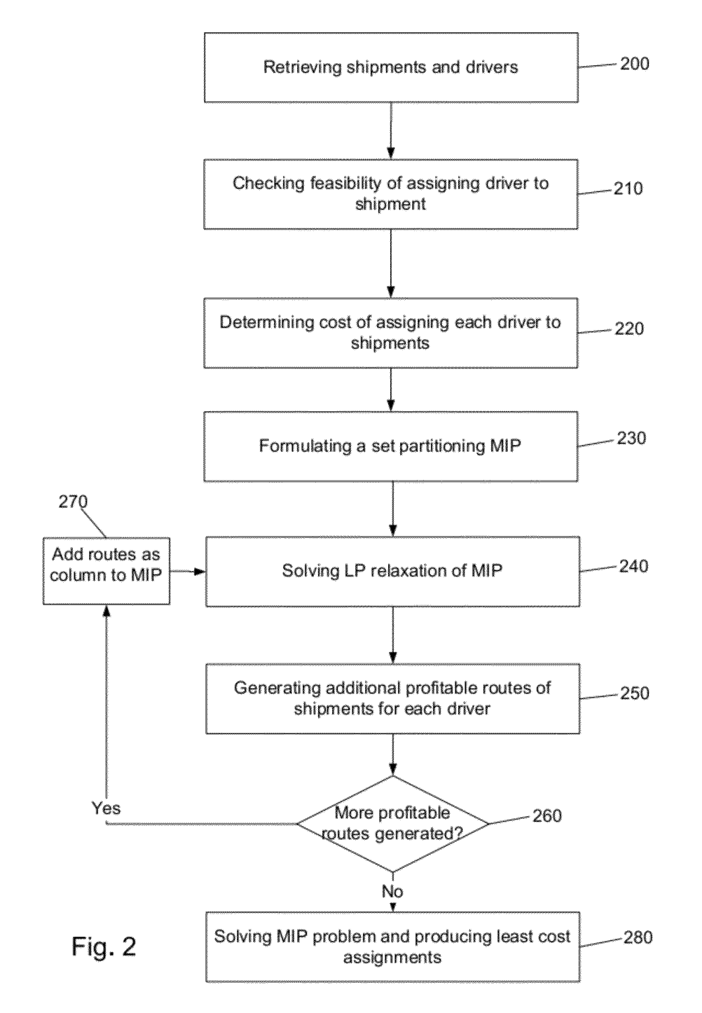

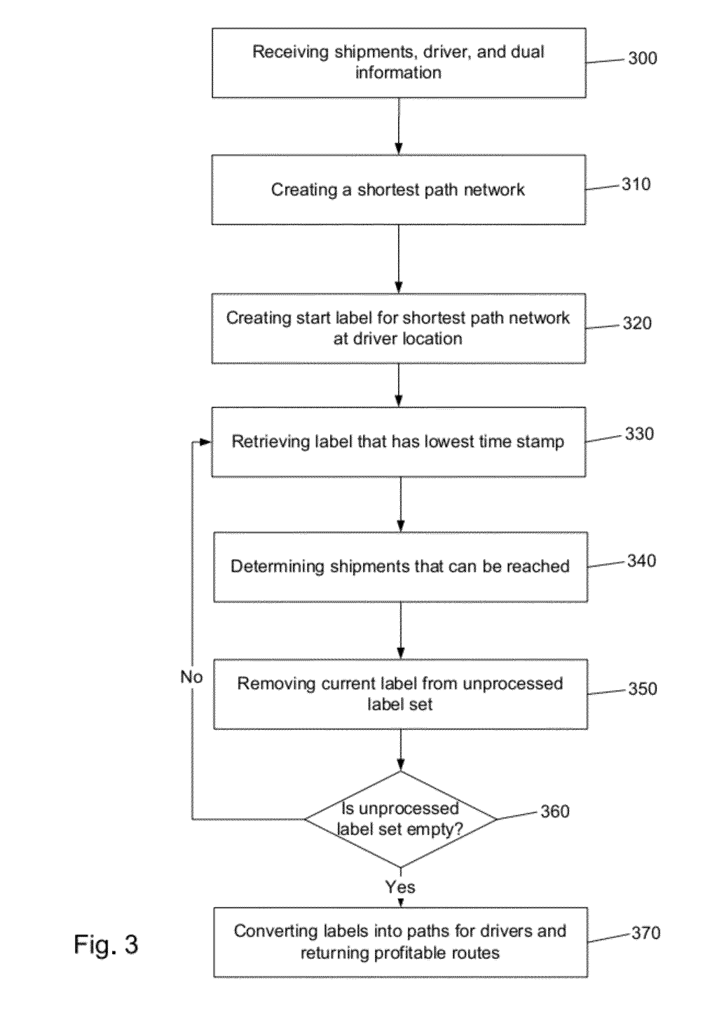

FIGS. 2 and 3 illustrate flow diagrams of the functionality of fleet dispatch module 16, according to an embodiment. It should be noted that the functionality of the flow diagrams depicted in FIGS. 2 and 3 can be implemented by software stored in memory or other computer readable or tangible media, and executed by a processor. In other embodiments, the functionality can be executed by hardware (e.g., through the use of an application specific integrated circuit (ASIC), a programmable gate array (PGA), a field programmable gate array (FPGA), or any combination of software and hardware.

FIG. 2 illustrates a flow diagram of one embodiment of a method that may be performed by fleet dispatch module 16. At 200, the method includes retrieving or receiving data from database system 30. The data may include, for example, shipments and drivers. For each possible pair of driver and shipment, the method includes, at 210, checking the feasibility of assigning the driver to the shipment. In one embodiment, checking the feasibility includes utilizing a simulation engine to simulate the driver delivering the shipment. The simulation may include, for example, determining how long it would take the driver to travel to the location(s) of the shipment(s), load the shipment(s) into the equipment (e.g., container or trailer), and then deliver the shipment(s) to their destination(s).

Moreover, the simulation engine will take into account the limitations on driving time for the driver, as mandated by local or federal rules and regulations, to better determine the overall time that a shipment will take to be delivered by the driver. For instance, some regulations require that a driver take an eight hour break after no more than ten hours of driving time. Additionally, other regulations may place a cap on the overall driving time a driver can undertake in a week or month, for example. Accordingly, the simulation engine will consider these rules when simulating the delivery of a shipment by a certain driver and determining the overall shipment time.

As an example, a shipment may have a deadline by which it must be delivered to its destination. The simulation engine will simulate a driver delivering that shipment as discussed above. If the simulation determines that the driver can deliver the shipment in time for the deadline while taking into account any constraints on the driver, then the simulation will conclude that it is feasible to assign the driver to that shipment. If, however, the simulation determines that the driver will not be able to make the shipment by the deadline due to driver constraints, distance, or any other reason, then the simulation will conclude that the assignment of the driver to that shipment is not feasible. For example, if the simulation of an assignment of a driver to a shipment results in the driver exceeding their hours limit, then that assignment is determined as being not feasible.

At 220, the method continues by determining the cost of assigning each of the drivers to each of the shipments. The cost may include, for example, the time it would take the driver to reach the shipment location, the type of equipment the driver is using or hauling while driving to the shipment, the fuel costs associated with reaching the shipment location and then delivering the shipment to its final destination, along with any intermediate stops, such as the time required for dropping off and picking up a piece of equipment, and any driver rest time that may be required. In one embodiment, the cost may be determined by a rating engine. According to certain embodiments, the rating engine may be a module within system 10 of FIG. 1, for example. The rating engine is configured to receive, as input, a route (or shipment) and then determine the cost of performing the pickup, driving, and delivery activities on the shipment while taking into account several user defined rating components, such as per mile cost, cost of loading and unloading equipment, stop off charges, etc.

At 230, the method includes formulating a set partitioning mixed integer programming (MIP) problem with each shipment as a row (or constraint) and each assignment as a column (or variable) of the MIP. The formulation of the set partitioning MIP may include setting up the objective function based on an objective of the assignment of a driver to a shipment. In one embodiment, the objective function is the cost of the assignment. Then, at 240, the method includes solving the linear programming (LP) relaxation of the MIP that was previously formulated at 230.

At 250, the method includes, for each driver, generating additional profitable routes for delivering the shipments. The generating of these additional profitable routes may be performed using duals or shadow prices that are produced when the LP relaxation is solved at 240. Each constraint in a LP problem is associated with a dual or shadow price. A shadow price may be considered to be the change in the objective value of an optimization problem obtained by relaxing the constraint by one unit. In the context of a set covering problem, the duals represents the “value” of servicing a shipment. Thus, a driver route that includes servicing several shipments contains the total cost for the shipments and total “value” of visiting those shipments. For a particular driver route, if the total cost is less than the total value of the shipments in the route, then the route is termed profitable and worthy of adding to the LP as an additional column. A process for generating the additional profitable routes will be discussed in more detail below in connection with FIG. 3.

In one embodiment, the shadow prices include an indication of the cost of violating a constraint and an indication of whether additional or different driver and shipment assignment combinations can be generated. Using the duals and/or shadow prices, any additional profitable shipment routes are generated.

At 260, the method includes checking whether any more profitable routes were generated at 250. If a more profitable route was generated, then the method includes adding the route as a column to the MIP at 270, and returning to 240 to solve the LP relaxation of the MIP. If no more profitable routes were generated, then the method continues, at 280, by solving the MIP problem optimally using all the routes generated and producing the least cost assignments of drivers to shipments.

FIG. 3 illustrates an example of a flow diagram of a method for generating shipment routes, according to one embodiment. At 300, the method includes receiving, as input, shipments, a driver for those shipments, and dual information. The dual information may include, for instance, information related to the profitability of the shipment, as discussed above. The result of the method shown in FIG. 3 is to generate at least one route for the driver to take to deliver the shipments.

At 310, the method includes creating a shortest path network for the delivery based on the location of the shipments and their destinations. In one embodiment, each of the driver location and shipment destination locations are nodes in the path. In one embodiment, the creation of the shortest path may be performed using, for example, a shortest path algorithm with the driver and shipments as nodes. The costs of the drivers and shipments may be updated using duals from the LP relaxation solved at 240 in FIG. 2 as discussed above.

At 320, the method includes creating the start label for the shortest path network at the driver node, which is the current or beginning location of the driver. Similarly, each node in the path is associated with a label. The label may contain, for example, information relating to the cost of the label, path (with all shipments covered), distance, the driver's current hours with respect to department of transportation (DOT) requirements. Other information about the driver, path or shipments may also be included in the label as appropriate. In addition, the label is associated with a time stamp that indicates the time at which the driver arrives at the node for that label. The created label is then added to an unprocessed label set stored in memory. At 330, the method includes retrieving the label L that has the lowest time stamp from the unprocessed label set. Initially, the label L that will be retrieved is the label associated with the driver node since that is the beginning location of the driver.

At 340, the method includes determining the shipment(s) that can be reached or delivered from the label L previously retrieved at 330. These shipment(s) should not yet have been covered by the label path. According to an embodiment, every shipment node is labeled, while removing other labels at the shipment node if the current label dominates. The dominant label is added to a list of labels for that node. A label is considered to dominate if it is less expensive and the shipment arrives sooner. If there is a label that is less expensive and another that arrives sooner, then both labels are added to the list of labels at that node or shipment. The list of labels for the node is added to the unprocessed label set. In one embodiment, the labeling of every shipment node utilizes the rating engine and simulation engine to validate the driver assignment and find the true cost of the assignment.

At 350, the method includes removing the current label L from the unprocessed label set. Then, at 360, it is determined whether the unprocessed label set is empty. If the unprocessed label set is not empty, then the method returns to 330 to retrieve the next label from the unprocessed label set. If the unprocessed label set is empty, then the method proceeds to 370 where, for each shipment, all the labels are retrieved and converted into paths for the driver. The route(s) resulting from those paths that have negative reduced costs, i.e., profitable routes, are returned. As a result, the method of FIG. 3 results in a profitable route generated for the shipments and driver that were provided as input.

According to certain embodiments, fleet dispatch module 16 is capable of stringing together multiple shipments to assign to the driver, which is referred to as shipment stringing. The capability of shipment stringing can be activated or de-activated depending on the situation or user preference. When shipment stringing, fleet dispatch module 16 can evaluate assigning one shipment to the driver as well as assigning the one shipment and the subsequent shipment. In some embodiments, fleet dispatch module 16 can be configured to select stringing multiple shipments for one driver, as opposed to giving the shipments to multiple drivers.

As discussed above, one embodiment of the invention formulates and solves relaxed LP problems for the MIP. The data outlined below is at least some of the data from which the LP problems are formulated and solved. The dual values for the rows of the relaxed LP will be used to evaluate the addition of newly generated columns (driver assignments) for the MIP. Once all interesting columns have been generated, the final MIP will be solved. The solution to this MIP will be a selection of shipment assignments for drivers.

A StrungShipmentAssignment represents a driver assignment to a series of shipments strung together. A driver constraint, enforcing that no more than one StrungShipmentAssignment is selected for each driver, is represented by the following:

$${\sum }_{i} {a}_{ir} {x}_{i} + {S}_{r} = 1$$

A shipment constraint, enforcing that, for each shipment, at most one StrungShipmentAssignment involving that shipment is selected, is represented by the following:

$${\sum }_{i} {b}_{is} {x}_{i} + {SS}_{s} = 1$$

The objective function for minimization is the sum of the costs for all selected StrungShipmentAssignment(s) as follows:

$${\sum }_{i} {C}_{i} {x}_{i} + {\sum }_{r} {P}_{r} {S}_{r} + {\sum }_{S} {PP}_{s} {SS}_{S}$$

The following is a description of the variables used in the above constraints or functions:

xᵢ is a binary variable that equals 1 if StrungShipmentAssignment i is selected;

Cᵢ is the cost of selecting StrungShipmentAssignment i;

aᵢᵣ is a binary variable where 1 indicates that StrungShipmentAssignment i is for Driver r;

bᵢₛ is a binary value wherein 1 indicates that StrungShipmentAssignment i includes shipment s;

Pᵣ is a penalty for selecting an assignment for driver r (this penalty can be used to encourage the selection of more valuable drivers, e.g., most valuable driver has penalty of 0);

PPₛ is a penalty for selecting an assignment for shipment s (this penalty can be used to encourage the selection of more valuable shipments, e.g., most valuable shipment has penalty of 0);

Sᵣ is a binary slack variable indicating whether driver r is included in an assigned strung shipment. This variable can take on a value of 1 if the number of StrungShipmentAssignment(s) selected for driver r is 0 and can take on the value of 0 if the number of StrungShipmentAssignment(s) selected for driver r is 1; and

SSₛ is a binary slack variable indicating whether shipment s is included in a strung shipment assignment. This variable can take on the value of 1 if the number of StrungShipmentAssignment(s) selected for shipment s is 0 and can take on the value of 0 if the number of StrungShipmentAssignment(s) selected for shipment s is 1.

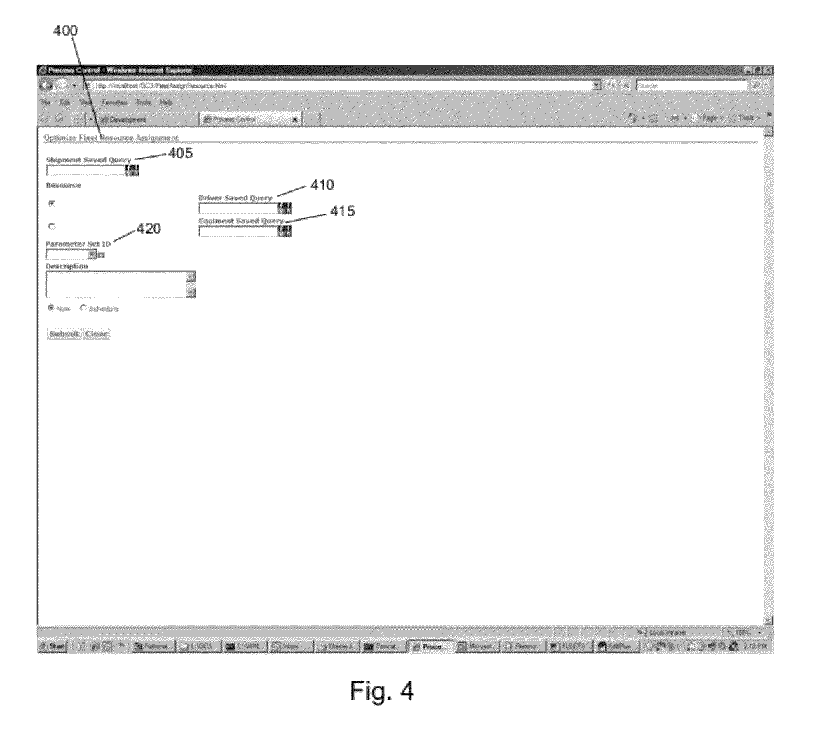

FIG. 4 illustrates an example of an optimum fleet resource assignment user interface 400 that can be used to assign drivers and/or equipment to a string of shipments. The user interface 400 includes a shipment saved query section 405, a driver saved query section 410, an equipment saved query section 415, and a parameter set ID section 420. A user can specify the shipments that are to be assigned by entering them in the text box of the shipment saved query 405. The user can select to assign drivers or equipment by selecting the radio button adjacent to the driver saved query 410 or the equipment saved query 415. The user can also specify the parameters to be applied to the assignment of the drivers to shipments via the drop down box of parameter set ID section 420.

In one embodiment, the assigning of one equipment to a shipment can be performed by a compatibility engine. The compatibility engine is configured to check if the equipment and shipment are compatible. For instance, the equipment may not be compatible with the shipment if it is not the correct size, shape or type. As an example, some shipments may require refrigeration and compatibility engine is able to check and conclude that any non-refrigerated containers are incompatible with the shipment requiring refrigeration.

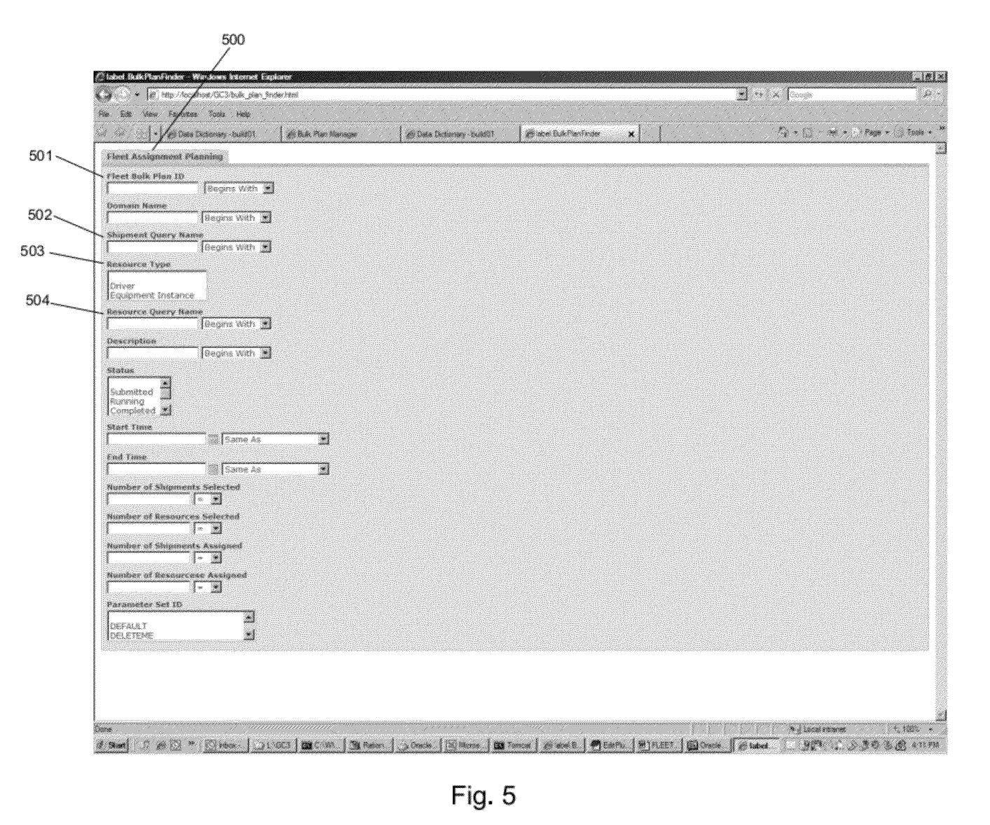

FIG. 5 illustrates an example of a fleet assignment planning user interface 500 that can be used to assist in the assignment of drivers and/or equipment to one or more shipments. The fleet assignment planning user interface 500 includes a fleet bulk plan ID section 501 for optionally specifying a fleet bulk plan ID that can be used to identify a certain assignment of drivers and/or equipment to shipments. Alternatively, the system can generate the fleet bulk plan ID using, for example, the current date and a number from 0001 to 9999. Shipment query name section 502 can be used to specify a query name used to retrieve shipments to be assigned from database system 30, for example. Similarly, resource query name section 504 can be used to enter a query name to retrieve resources (drivers or equipment) to be assigned from database system 30. Resource type 503 is a selection box that allows a user to select driver and/or equipment for assignment.

Embodiments of the invention provide a plurality of parameters or constraints that can be applied when determining the optimized driver assignment and/or route for the shipments. For example, the parameters may include:
1. Maximum number of shipments in string: This is the maximum number of shipments that can be strung together. For example, if this parameter is set to 4 then the number of shipments assigned to one driver during this process cannot exceed 4.
2. Strung shipments maximum duration: The start time of the first shipment in a strung shipment to the end time of the last shipment in the strung shipment cannot exceed the value of this parameter. For example, if a driver can only work 10 hours during a day under state or federal regulations, this parameter can be set to 10 to ensure that the duration of the driver's strung shipments will not exceed 10 hours.
3. Maximum distance between shipments: This parameter can be used to specify that two shipments should not be strung together if the distance between them exceeds the value of the parameter.
4. Maximum time between shipments: The duration between one shipment's end time to the next shipment's start time cannot exceed the value defined by this parameter.
5. Evaluate equipment type using cost: If the value of this parameter is true, then the real cost of the equipment type to a shipment will be calculated through the rating engine during the evaluation process of the optimization. If the value is false, then the evaluation of equipment type will be based on distance.

Embodiments of the invention are not limited to the parameters outlined above and other parameters are supported or can be added. In one embodiment, the parameters are assigned initial default values that can be changed by the user based on their requirements.

It should be noted that many of the functional features described in this specification have been presented as modules, applications or the like, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be partially implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve its stated purpose.

Indeed, a module of executable code or algorithm could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer program, embodied on a computer readable medium, the computer program configured to control a processor to perform a process, comprising:
retrieving a list of available drivers and shipments;
determining feasibility of assigning one of the drivers to one of the shipments;
determining a cost of assigning each of the drivers to each of the shipments; and
selecting a lowest cost assignment of a driver to the shipments based on a result of the determining.

2. The computer program according to claim 1, wherein the drivers comprise private fleet drivers and common carrier drivers.

3. The computer program according to claim 1, wherein the determining the feasibility comprises simulating, by a simulation engine, delivery of the one of the shipments by the one of the drivers.

4. The computer program according to claim 1, wherein the determining the cost comprises formulating a set partitioning mixed integer programming (MIP) problem using each of the shipments.

5. The computer program according to claim 4, wherein the determining the cost further comprises solving linear programming (LP) relaxation of the MIP.

6. The computer program according to claim 5, wherein the determining the cost further comprises generating additional profitable routes of shipments for each of the drivers.

7. The computer program according to claim 6, wherein the generating comprises:
creating a shortest path network with one of the drivers and each of the shipments as nodes in the network;
creating a start label as the driver node and adding the label to an unprocessed label set;
retrieving a label with a lowest time stamp from the unprocessed label set;
determining the nodes for the shipments that can be reached from the retrieved label and creating a label for the determined nodes;
adding the created label to the unprocessed label set;
removing a current label from the unprocessed label set;
when unprocessed label set is empty, returning at least one route between the nodes having negative reduced costs.

8. An apparatus, comprising:
at least one processor; and
at least one memory including computer program code,
the at least one memory including the computer program code is configured, with the at least one processor, to cause the apparatus to
retrieve a list of available drivers and shipments;
determine feasibility of assigning one of the drivers to one of the shipments;
determine a cost of assigning each of the drivers to each of the shipments; and
select a lowest cost assignment of a driver to the shipments based on a result of the determining.

9. The apparatus according to claim 8, wherein the drivers comprise private fleet drivers and common carrier drivers.

10. The apparatus according to claim 8, wherein the determining the feasibility comprises simulating, by a simulation engine, delivery of the one of the shipments by the one of the drivers.

11. The apparatus according to claim 1, wherein the determining the cost comprises formulating a set partitioning mixed integer programming (MIP) problem using each of the shipments.

12. The apparatus according to claim 11, wherein the determining the cost further comprises solving linear programming (LP) relaxation of the MIP.

13. The apparatus according to claim 12, wherein the determining the cost further comprises generating additional profitable routes of shipments for each of the drivers.

14. A method, comprising:
retrieving a list of available drivers and shipments;
determining feasibility of assigning one of the drivers to one of the shipments;
determining a cost of assigning each of the drivers to each of the shipments; and
selecting a lowest cost assignment of a driver to the shipments based on a result of the determining.

15. The method according to claim 14, wherein the drivers comprise private fleet drivers and common carrier drivers.

16. The method according to claim 14, wherein the determining the feasibility comprises simulating, by a simulation engine, delivery of the one of the shipments by the one of the drivers.

17. The method according to claim 14, wherein the determining the cost comprises formulating a set partitioning mixed integer programming (MIP) problem using each of the shipments.
